(19) United States
(12) Patent Application Publication
(10) Pub. No.: US 2013/0138399 A1
(43) Pub. Date: May 30, 2013

(54) Generating an Analytically Accurate Model From an Abstract Representation Created Via a Mobile Device

(71) Applicant: Garrick EVANS, San Francisco, CA (US)

(72) Inventor: Garrick EVANS, San Francisco, CA (US)

(21) Appl. No.: 13/306,895

(22) Filed: Nov. 29, 2011

(51) Int. Cl. G06F 17/50

(52) U.S. Cl. 703/1

(57) ABSTRACT

One embodiment of the present invention is a method that includes receiving a plurality of user gestures that define a sketch of one or more objects, and converting the plurality of user gestures into an abstract representation of the one or more objects. The abstract representation of the one or more objects is convertible, without any additional user input, into an analytically accurate model of the one or more objects. Advantageously, embodiment of the present invention optimize how each of a mobile computing device and a computer system is used to generate object models, thereby enhancing the viability of the mobile computing device as a drawing/modeling platform

### BACKGROUND OF THE INVENTION

1. Field of the Invention

The present invention relates generally to computer-aided design software and, more specifically, to generating an analytically accurate model from an abstract representation created via a mobile device.

2. Description of the Related Art

Computer-aided design (CAD) software applications are well-known in the art and are used to generate many different types of designs and models, including architectural, mechanical, and graphics designs and models. One drawback of CAD software applications and other modeling software applications is that such applications are complex, complicated to use, and require a good amount of processing power and memory to create and store analytically accurate designs and models. Consequently, CAD software applications and other modeling software applications cannot be implemented effectively on mobile computing devices. Among other things, users of mobile devices oftentimes do not have the time necessary to generate analytically accurate designs or models using conventional CAD or other modeling software applications, many mobile computing devices do not have the processing power necessary to run large and complex CAD or other modeling software applications, many mobile computing devices do not have the memory capacity necessary to store analytically accurate designs and models, and running complex and computationally intensive software applications drains batter power.

As the foregoing illustrates, what is needed in the art is an approach that allows mobile computing devices to be used more effectively as a drawing/modeling platform.

### SUMMARY OF THE INVENTION

One embodiment of the present invention sets forth a method for generating an analytical model of one or more objects. The method includes receiving a plurality of user gestures that define a sketch of one or more objects, and converting the plurality of user gestures into an abstract representation of the one or more objects. The abstract representation of the one or more objects is convertible, without any additional user input, into an analytically accurate model of the one or more objects.

Other embodiments of the present invention include a system configured to implement the above method as well as a computer-readable medium including instructions that, when executed by a processing unit, cause the processing unit to implement the above method.

On advantage of the disclosed method is that, among other things, it optimizes how a mobile computing device and a computer system are used to generate object models, thereby enhancing the viability of the mobile computing device as a drawing/modeling platform.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments:

FIG. 1 illustrates a system configured to implement one or more aspects of the present invention;

FIG. 2 illustrates a computing device configured to implement one or more aspects of the present invention;

FIG. 3A is a more detailed illustration of the mobile computing device of FIG. 1, according to one embodiment of the present invention;

FIG. 3B is a more detailed illustration of the computer system of FIG. 1, according to one embodiment of the present invention; and

FIGS. 4A-4B set forth method steps for generating an analytically accurate model from an abstract representation created via a mobile device, according to one embodiment of the present invention.

### DETAILED DESCRIPTION

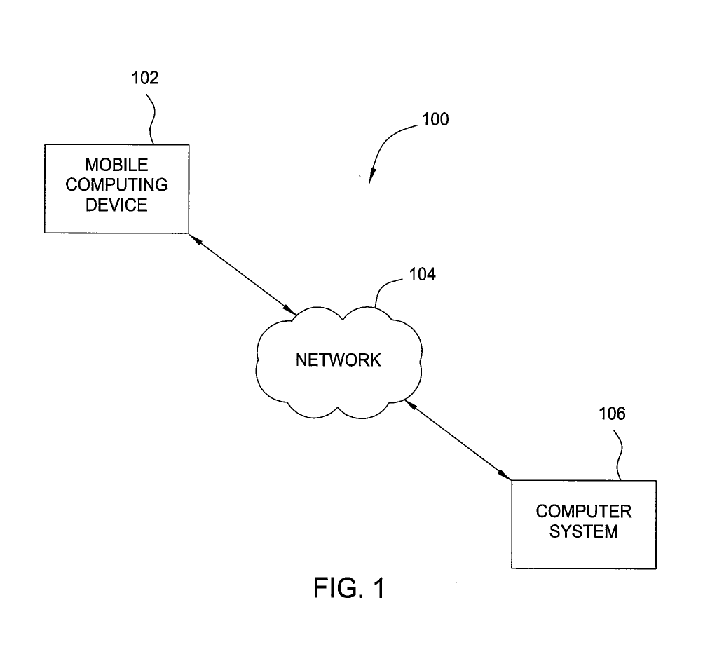

FIG. 1 illustrates a system 100 configured to implement one or more aspects of the present invention. As shown, the system 100 includes, without limitation, a mobile computing device 102 coupled to a computer system 106 through a network 104. The mobile computing device 102 may be any type of hand-held or portable computing device such as, without limitation, a laptop computer, a mobile or cellular telephone, a personal digital assistant, a tablet computing device, or the like. The mobile computing device 102 preferably includes a touch-screen element or other element configured to receive touch-based input from a user via finger movements or stylus movements. As is well-known, such movements may be either along or proximate to the touch-screen element or other touch-based input element. Further, during operation, the mobile computing device 102 may be further configured to present one or more graphical user interfaces (GUIs) that allow a user, through various pull-down menu options, different input elements, and the like, to provide commands, data and other input to the mobile computing device 102.

The computer system 106 may be any computing device that preferably has greater functionality as well as computing and power resources than the mobile computing device 102. In various embodiments, the computer system 106 may comprise a desk-top computing device, a server computing device, or the like. The network 104 may comprise any type of computing network such as, without limitation, a local area network, a wide area network, the internet, a home network, an enterprise network, or the like.

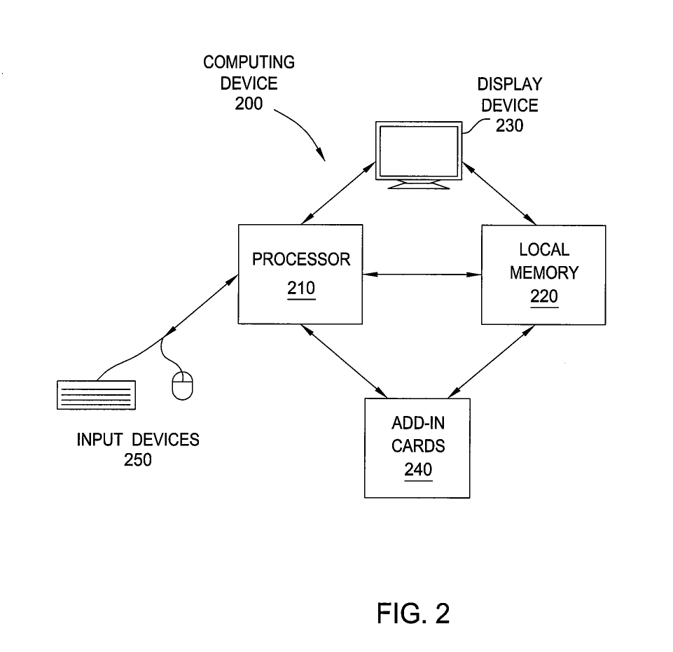

FIG. 2 illustrates a computing device 200 configured to implement one or more aspects of the present invention. As shown, the computing device 200 includes a processor 210, a local memory 220, a display 230, one or more add-in cards 240, and one or more input devices 250. The processor 210 includes a central processing unit (CPU) and is configured to carry out calculations and to process data. The local memory 220 is configured to store data and instructions. The display 230 is configured to display data. In one embodiment, the display is a touch screen and is configured to receive input by being touched by one or more fingers or styli. As persons skilled in the art will recognize, the processor 210, local memory 220, input devices 250 and display 230 may be included in any type of computing device or machine, such as the mobile computing device 102 or the computer system 106.

In various embodiments, wireless circuitry, the one or more add-in cards 140, or the like, may allow the computing device 200 to interact with one or more other machines over a computer network, such as the network 104. Input devices 150 are configured to allow an end-user to input commands and data into the computer system 100. In various embodiments, the input devices 150 may include a keyboard, a mouse, a touch-screen element, or any combination thereof.

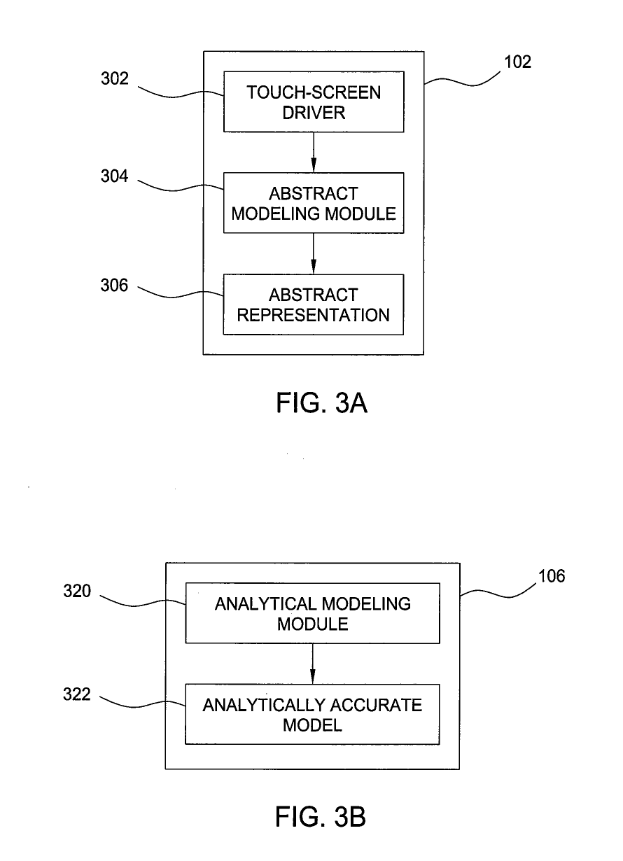

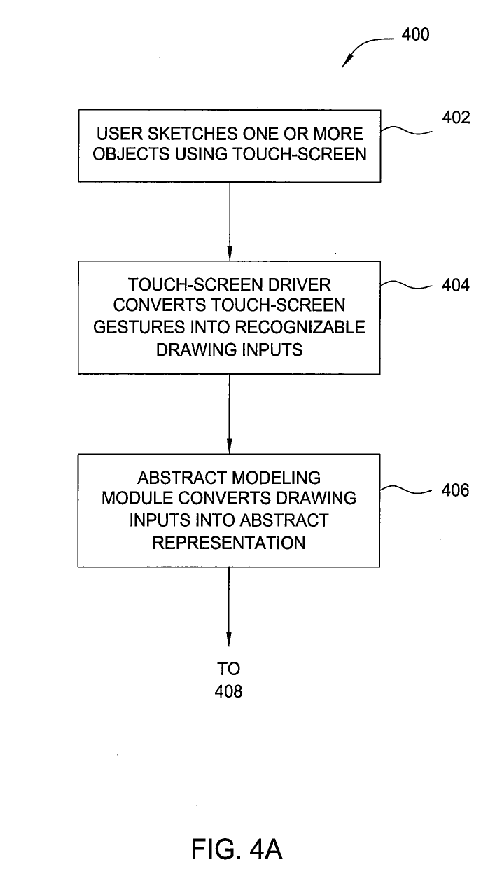

FIG. 3A is a more detailed illustration of the mobile device 102 of FIG. 1, according to one embodiment of the present invention. As shown, the mobile computing device 102 includes, without limitation, a touch-screen driver 302 and an abstract modeling module 304. In operation, a user of the mobile computing device 102 may produce a sketch of one or more objects by inputting, via a series of gestures along or proximate to the touch-screen (or other touch-input) element of the computing device 102, the contours of the one or more objects. In different embodiments, the series of gestures may comprise one or more finger movement, one or more stylus movements, one or more touch-based selections, or any combination thereof. The touch-screen driver 302 is configured to convert the series of gestures into drawing inputs that can be recognized by the abstract modeling module 304. Upon receiving the drawing inputs, the abstract modeling module 304 is configured to generate an abstract representation 306 of the one or more objects based on the drawing inputs. The mobile computing device 102 is configured to transmit the abstract representation 306, via the network 104, to the computer system 106 for further processing. In some embodiments, the abstract representation 306 may be stored locally within the mobile computing device 102.

As is described in greater detail herein, the abstract representation 306 of the one or more objects comprises a set of instructions or recipe that can be interpreted and converted, without any additional user input, into an analytically accurate model of the one or more objects. The analytically accurate model comprises a recipe that can be executed by a modeling software application, such as a computer-aided design software application, to generate an analytically accurate representation of the one or more objects.

FIG. 3B is a more detailed illustration of the computer system 106 of FIG. 1, according to one embodiment of the present invention. As shown, the computer system 106 includes, without limitation, an analytical modeling module 320. In operation, upon receiving the abstract representation 306 of the one or more objects from the mobile computing device 102, an interface element (not shown) within the computer system 106 is configured to provide the abstract representation 306 to the analytically modeling module 320 for additional processing. The analytical modeling module 320 is configured to interpret the abstract representation 306 of the one or more objects and then convert the set of commands or recipe making up the abstract representation 306 into an analytically accurate model 322 of the one or more objects. The analytical modeling module is configured to perform this functionality without any additional user input (i.e., without any additional data or commands). The analytically accurate model 322 comprises a recipe that can be executed by a computer-aided design software application or other modeling software application to produce an analytically accurate representation of the one or more objects. The analytically accurate model 322 may be stored locally within the computer system 106 and/or displayed.

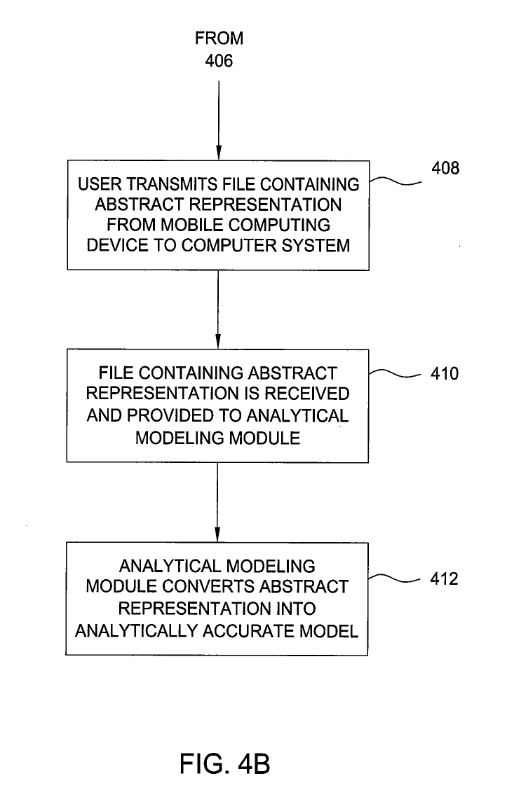

FIGS. 4A-4B set forth method steps for generating an analytically accurate model from an abstract representation created via a mobile device, according to one embodiment of the present invention. Although the method steps are described in conjunction with the systems of FIGS. 1-3B, persons skilled in the art will understand that any system configured to implement the method steps, in any order, falls within the scope of the present invention.

As shown, a method 400 begins at step 402, where a user of the mobile computing device 102 sketches one or more objects using the touch-screen element (or other touch-input element) of the mobile computing device 102. In different embodiments, the series of user gestures defining the contours of the sketch may comprise one or more finger movement, one or more stylus movements, one or more touch-based selections, or any combination thereof. At step 404, the touch screen driver 302 within the mobile computing device 102 converts the series of user gestures (i.e., the touch-screen or touch-input element gestures) into drawing inputs that can be recognized by the abstract modeling module 304 within the mobile computing device 102. At step 406, the abstract modeling module 304 converts the drawing inputs into an abstract representation 306 of the one or more objects.

At step 408, a user of the mobile computing device 102 causes the mobile computing device 102 to transmit the file containing the abstract representation 306 to the computer system 106 via the network 104. At step 410, the file containing the abstract representation 306 is received by an interface element within the computer system 106 and provided to the analytical modeling module 320, which also is within the computer system 106. At step 412, the analytical modeling module 320, without any additional user input, interprets the abstract representation 306 and converts the set of command or recipe making up the abstract representation 306 into an analytically accurate model 322 of the one or more objects. Again, the analytically accurate model 322 comprises a recipe that can be executed by a computer-aided design software application or other modeling software application to produce an analytically accurate representation of the one or more objects.

One advantage of the disclosed approach is that, by configuring a mobile computing device with an abstract modeling module and configuring a computer system that has more computational capabilities than the mobile computing device with a more complex analytical modeling module, the mobile computing device can be used to quickly and efficiently generate sketches and drawings that can later be converted into analytically accurate models by the computer system. Among other things, such an approach optimizes how each of the mobile computing device and the computer system is used to generate object models, thereby enhancing the viability of the mobile computing device as a drawing/modeling platform.

While the forgoing is directed to embodiments of the present invention, other and further embodiments of the invention may be devised without departing from the basic scope thereof. For example, aspects of the present invention may be implemented in hardware or software or in a combination of hardware and software. One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the present invention, are embodiments of the present invention.

The scope of the present invention is determined by the claims that follow.

What is claimed is:

1. A method for generating an analytical model of one or more objects, the method comprising:
receiving a plurality of user gestures that define a sketch of one or more objects; and
converting the plurality of user gestures into an abstract representation of the one or more objects,
wherein the abstract representation of the one or more objects is convertible, without any additional user input, into an analytically accurate model of the one or more objects.

2. The method of claim 1, wherein the plurality of user gestures comprises one or more finger movements along or proximate to a touch-screen element of a mobile computing device.

3. The method of claim 1, wherein the plurality of user gestures comprises one or more stylus movements along or proximate to a touch-screen element of a mobile computing device.

4. The method of claim 1, wherein the plurality of user gestures comprises at least one touch-based selection from a graphical user interface presented to a user of a mobile computing device.

5. The method of claim 1, further comprising transmitting the abstract representation of the one or more objects to a computer system for further processing.

6. The method of claim 5, further comprising converting, without any additional user input, the abstract representation of the one or more objects into the analytically accurate model of the one or more objects.

7. The method of claim 1, wherein the steps of receiving and converting are performed by a mobile computing device.

8. The method of claim 1, wherein the abstract representation of the one or more objects comprises a set of instructions or a recipe.

9. The method of claim 1, wherein the analytically accurate model of the one or more objects comprises a recipe that can be executed by a computer-aided design software application to generate an analytically accurate representation of the one or more objects.

10. A system, comprising:
a mobile computing device configured to:
receive a plurality of user gestures that define a sketch of one or more objects, and
convert the plurality of user gestures into an abstract representation of the one or more objects,
wherein the abstract representation of the one or more objects is convertible, without any additional user input, into an analytically accurate model of the one or, more objects.

11. The system of claim 10, wherein the plurality of user gestures comprises one or more finger movements along or proximate to a touch-screen element of the mobile computing device.

12. The system of claim 10, wherein the plurality of user gestures comprises one or more stylus movements along or proximate to a touch-screen element of the mobile computing device.

13. The system of claim 10, wherein the plurality of user gestures comprises at least one touch-based selection from a graphical user interface presented to a user of the mobile computing device.

14. The system of claim 10, further comprising a computer system, and the mobile computing device is further configured to transmit the abstract representation of the one or more objects to the computer system for further processing.

15. The system of claim 14, wherein the computer system is configured to convert, without any additional user input, the abstract representation of the one or more objects into the analytically accurate model of the one or more objects.

16. The system of claim 10, wherein the abstract representation of the one or more objects comprises a set of instructions or a recipe.

17. The system of claim 10, wherein the analytically accurate model of the one or more objects comprises a recipe that can be executed by a computer-aided design software application to generate an analytically accurate representation of the one or more objects.

18. A computer-readable medium including instructions that, when executed by a processing unit, cause the processing unit to generate an analytical model of one or more objects, by performing the steps of:
receiving a plurality of user gestures that define a sketch of one or more objects; and
converting the plurality of user gestures into an abstract representation of the one or more objects,
wherein the abstract representation of the one or more objects is convertible, without any additional user input, into an analytically accurate model of the one or more objects.

19. The computer-readable medium of claim 18, wherein the plurality of user gestures comprises one or more finger movements or stylus movements along or proximate to a touch-screen element of a mobile computing device.

20. The computer-readable medium of claim 18, wherein the analytically accurate model of the one or more objects comprises a recipe that can be executed by a computer-aided design software application to generate an analytically accurate representation of the one or more objects.
